(19) United States
(12) Patent Application Publication
(10) Pub. No.: US 2021/0216994 A1
(43) Pub. Date: Jul. 15, 2021

(54) METHODS AND SYSTEMS FOR PROCESSING A TRANSACTION

(71) Applicant: Capital One Services, LLC, McLean, VA (US)

(72) Inventor: Mark SORBELLO, Richmond Hill (CA)

(73) Assignee: Capital One Services, LLC, McLean, VA (US)

(21) Appl. No.: 16/739,535

(22) Filed: Jan. 10, 2020

(51) Int. Cl. G06Q 20/32; G06Q 20/34; G06Q 20/40; G06F 3/03

(52) U.S. Cl. CPC G06Q 20/3224; G06Q 20/352; G06Q 2220/00; G06Q 20/4016; G06F 3/0304; G06Q 20/40145

(57) ABSTRACT

A computer-implemented method for processing a transaction may include obtaining first activity data of an electronic device associated with a user, wherein the first activity data includes at least a first action pattern performed by the user with the electronic device; determining a status of the electronic device based on the first activity data, wherein the status of the electronic device includes an active status of the electronic device enabling the electronic device to process the transaction; obtaining second activity data of the electronic device based on the status of the electronic device, wherein the second activity data includes at least a second action pattern performed by the user with the electronic device; determining transaction data associated with the transaction based on the second activity data, wherein the transaction data includes at least a transaction amount of the transaction; and processing the transaction based on the transaction data.

### TECHNICAL FIELD

Various embodiments of the present disclosure relate generally to processing a transaction, and, more particularly, to processing the transaction via a contactless payment process.

### BACKGROUND

Contactless payment processing methods may include the use of financial cards (e.g., credit cards, debit cards, smart card, etc.) or other such electronic devices equipped with radio-frequency identification and/or near field communication capabilities to make payments. However, such contactless payment methods may insufficiently protect users. For example, such contactless payment methods may fail to ensure that a transaction is initiated by the owner (e.g., a user) of the financial card or other electronic device. This can lead to transactions without the owner's permission or interaction.

The present disclosure is directed to overcoming the above-referenced challenge. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for processing a transaction via a contactless payment process. The methods and systems may provide a mechanism that verifies, authenticates, or processes such a transaction.

In an aspect, a computer-implemented method for processing a transaction may include: obtaining, via one or more processors, first activity data of an electronic device associated with a user, wherein the first activity data includes at least a first action pattern performed by the user with the electronic device; determining, via the one or more processors, a status of the electronic device based on the first activity data, wherein the status of the electronic device includes an active status of the electronic device enabling the electronic device to process the transaction; obtaining, via the one or more processors, second activity data of the electronic device based on the status of the electronic device, wherein the second activity data includes at least a second action pattern performed by the user with the electronic device; determining, via the one or more processors, transaction data associated with the transaction based on the second activity data, wherein the transaction data includes at least a transaction amount of the transaction; and processing, via the one or more processors, the transaction based on the transaction data.

In another aspect, a computer-implemented method for processing a transaction may include: obtaining, via one or more processors, first activity data of a transaction vehicle associated with a user, wherein the obtaining the first activity data of the transaction vehicle includes obtaining the first activity data via one or more sensors associated with the transaction vehicle, wherein first activity data includes at least a first action pattern performed by the user with the transaction vehicle; determining, via the one or more processors, a status of the transaction vehicle based on the first activity data, wherein the status of the transaction vehicle includes an active status of the transaction vehicle enabling the transaction vehicle to process the transaction; obtaining, via the one or more processors, second activity data of the transaction vehicle based on the status of the transaction vehicle, wherein obtaining the second activity data of the transaction vehicle includes obtaining the second activity data via the one or more sensors associated with the transaction vehicle, wherein the second activity data includes at least a second action pattern performed by the user with the transaction vehicle; determining, via the one or more processors, transaction data associated with the transaction based on the second activity data, wherein the transaction data includes at least a transaction amount of the transaction; and processing, via the one or more processors, the transaction based on the transaction data.

In yet another aspect, a computer system for processing a transaction may include a memory storing instructions and one or more processors configured to execute the instructions to perform operations. The operations may include: obtaining first activity data of an electronic device associated with a user, wherein the first activity data includes at least a first action pattern performed by the user with the electronic device; determining a status of the electronic device based on the first activity data, wherein the status of the electronic device includes an active status of the electronic device enabling the electronic device to processing the transaction; obtaining second activity data of the electronic device based on the status of the electronic device, wherein the second activity data includes at least a second action pattern performed by the user with the electronic device; determining transaction data associated with the transaction based on the second activity data, wherein the transaction data includes at least a transaction amount of the transaction; and processing the transaction based on the transaction data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of processing a transaction, according to one or more embodiments.

FIG. 3 depicts a flowchart of another exemplary method of processing a transaction, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as first activity data and second activity data, may be used to determine whether and how to process a transaction.

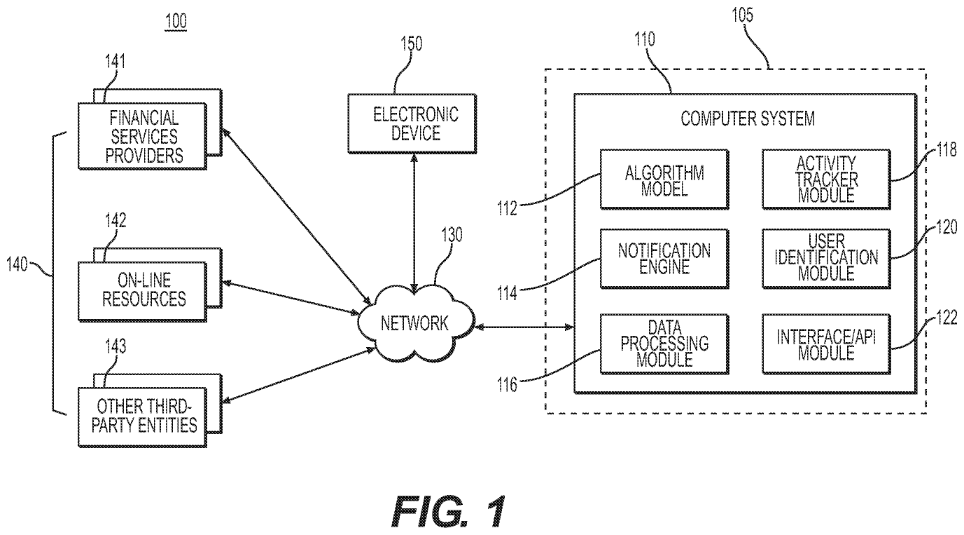

FIG. 1 is a diagram depicting an example of a system environment 100 according to one or more embodiments of the present disclosure. The system environment 100 may include a computer system 110, a network 130, one or more resources for collecting data 140 (e.g., first activity data and second activity data), and an electronic device (or a device associated with a user) 150. The one or more resources for collecting data 140 may include financial services providers 141, on-line resources 142, or other third-party entities 143. These components may be connected to one another via network 130.

The computer system 110 may have one or more processors configured to perform methods described in this disclosure. The computer system 110 may include one or more modules, models, or engines. The one or more modules, models, or engines may include an algorithm model 112, a notification engine 114, a data processing module 116, an activity tracker module 118, a user identification module 120, and/or an interface/API module 122, which may each be software components stored in the computer system 110. The computer system 110 may be configured to utilize one or more modules, models, or engines when performing various methods described in this disclosure. In some examples, the computer system 110 may have a cloud computing platform with scalable resources for computation and/or data storage, and may run one or more applications on the cloud computing platform to perform various computer-implemented methods described in this disclosure. In some embodiments, some of the one or more modules, models, or engines may be combined to form fewer modules, models, or engines. In some embodiments, some of the one or more modules, models, or engines may be separated into separate, more numerous modules, models, or engines. In some embodiments, some of the one or more modules, models, or engines may be removed while others may be added.

The algorithm model 112 may be a plurality of algorithm models. The algorithm model 112 may include a trained machine learning model. Details of algorithm model 112 are described elsewhere herein. The notification engine 114 may be configured to generate and communicate (e.g., transmit) one or more notifications (e.g., a notification demonstrating a transaction amount) to an electronic device 150 or to one or more resources 140 through the network 130. The data processing module 116 may be configured to manage, clean, process, or standardize data (e.g., first activity data and second activity data) received by the computer system 110. One or more algorithms may be used to clean, process, or standardize the data. The activity tracker module 118 may be configured to monitor or track activity data (e.g., first activity data and second activity data). The activity tracker module 118 may be associated with one or more activity acquiring devices (e.g., sensors, imaging devices) to obtain the activity data. The user identification module 120 may manage user identification for each user accessing the computer system 110. In some embodiments, the user identification may be defined based on first activity data or second activity data. In one implementation, the user identification associated with each user may be stored to, and retrieved from, one or more components of data storage associated with the computer system 110 or one or more resources 140. The interface/API module 122 may allow the user to interact with one or more modules, models, or engines of the computer system 110.

Computer system 110 may be configured to receive data from other components (e.g., one or more resources 140, or electronic device 150) of the system environment 100 via network 130. Computer system 110 may further be configured to utilize the received data by inputting the received data into the algorithm model 112 to produce a result (e.g., transaction data). Information indicating the result may be transmitted to electronic device 150 or one or more resources 140 over network 130. In some examples, the computer system 110 may be referred to as a server system that provides a service including providing the information indicating the received data and/or the result to one or more resources 140 or electronic device 150.

Network 130 may be any suitable network or combination of networks and may support any appropriate protocol suitable for communication of data to and from the computer system 110 and between various other components in the system environment 100. Network 130 may include a public network (e.g., the Internet), a private network (e.g., a network within an organization), or a combination of public and/or private networks. Network 130 may be configured to provide communication between various components depicted in FIG. 1. Network 130 may comprise one or more networks that connect devices and/or components in the network layout to allow communication between the devices and/or components. For example, the network may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 130 may be implemented using cell and/or pager networks, satellite, licensed radio, or a combination of licensed and unlicensed radio.

Financial services providers 141 may be an entity such as a bank, credit card issuer, merchant services providers, or other type of financial service entity. In some examples, financial services providers 141 may include one or more merchant services providers that provide merchants with the ability to accept electronic payments, such as payments using transaction vehicles (e.g., credit cards, debit cards, smart cards, etc.). Therefore, financial services providers 141 may collect and store data pertaining to transactions occurring at the merchants. In some embodiments, financial services providers 141 may provide a platform (e.g., an app on an electronic device) or a device (e.g., a reader) with which a user or a transaction vehicle can interact. The financial services providers 141 may include one or more databases to store any information related to the user.

On-line resources 142 may include webpage, e-mail, apps, or social networking sites. On-line resources 142 may be provided by manufacturers, vehicle dealers, retailers, consumer promotion agencies, and other entities. For example, on-line resources may include a webpage that a user can access to buy or sell a product. On-line resources 142 may include other computer systems, such as web servers, that are accessible by computer system 110. On-line resources 142 may be associated with or provided by the financial services providers 141.

Other third-party entities 143 may be any entity that is not a financial services provider 141 or on-line resources 142. The other third-party entity 143 may include a merchant. Other third-party entities 143 may include merchants that may each be an entity that provides products. The term “product,” in the context of products offered by a merchant, encompasses both goods and services, as well as products that are a combination of goods and services. A merchant may be, for example, a retailer, a vehicle dealer, a grocery store, an entertainment venue, a service provider, a restaurant, a bar, a non-profit organization, or other type of entity that provides products that a consumer may consume. A merchant may have one or more venues that a consumer physically visits in order to obtain the products (goods or services) offered by the merchant. In some embodiments, the other third-party entity 143 may provide a platform (e.g., an app on an electronic device) or a device (e.g., a reader) with which a user or a transaction vehicle can interact. The other third-party entity 143 may include one or more databases to store any information related to the user.

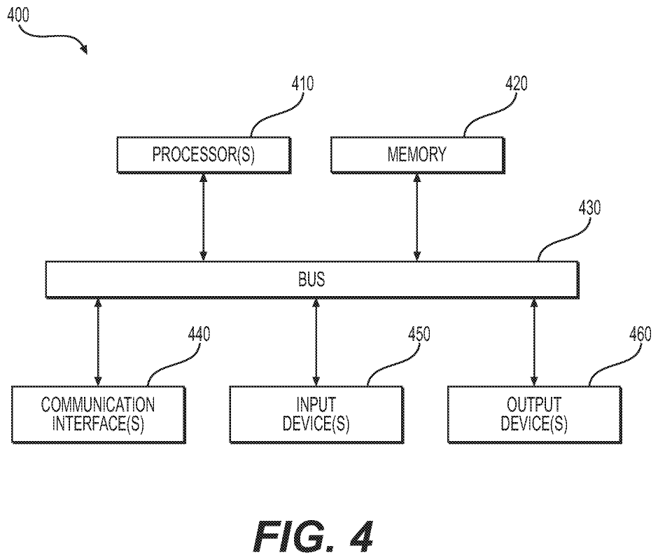

The financial services providers 141, the on-line resources 142, or any other type of third-party entities 143 may each include one or more computer systems configured to gather, process, transmit, and/or receive data. In general, whenever any of financial services providers 141, the on-line resources 142, or other type of third-party entities 143 is described as performing an operation of gathering, processing, transmitting, or receiving data, it is understood that such an operation may be performed by a computer system thereof. In general, a computer system may include one or more computing devices, as described in connection with FIG. 4 below.

Electronic device 150 may operate a client program, also referred to as a user application or third-party application, used to communicate with the computer system 110. The client program may be provided by the one or more sources 140. A user may use the client program to perform a transaction. This user application may be used to accept user input or provide information to the computer system 110 and to receive information from the computer system 110. In some examples, the user application may be a mobile application that is run on electronic device 150. Electronic device 150 may be a mobile device (e.g., smartphone, tablet, pager, personal digital assistant (PDA)), a computer (e.g., laptop computer, desktop computer, server), or a wearable device (e.g., smart watch). Electronic device 150 can also include any other media content player, for example, a set-top box, a television set, a video game system, or any electronic device capable of providing or rendering data. Electronic device 150 may optionally be portable. The electronic device may be handheld. Electronic device 150 may be a network device capable of connecting to a network, such as network 130, or other networks such as a local area network (LAN), wide area network (WAN) such as the Internet, a telecommunications network, a data network, or any other type of network. Further details of the electronic device are described elsewhere herein. In some embodiments, electronic device 150 may be a transaction vehicle, such as a card. The card may be a financial transaction card such as a credit card or a debit card, a membership card, a reward card, or an identification card such as a driver's license. Details of the transaction vehicle or the card are described elsewhere herein.

Computer system 110 may be part of an entity 105, which may be any type of company, organization, or institution. In some examples, entity 105 may be a financial services provider. In such examples, the computer system 110 may have access to data pertaining to transactions through a private network within the entity 105. For example, if the entity 105 is a card issuer, entity 105 may collect and store data (e.g., pre-stored activity data) involving a credit card or debit card issued by the entity 105. In such examples, the computer system 110 may still receive data from other financial services providers 141.

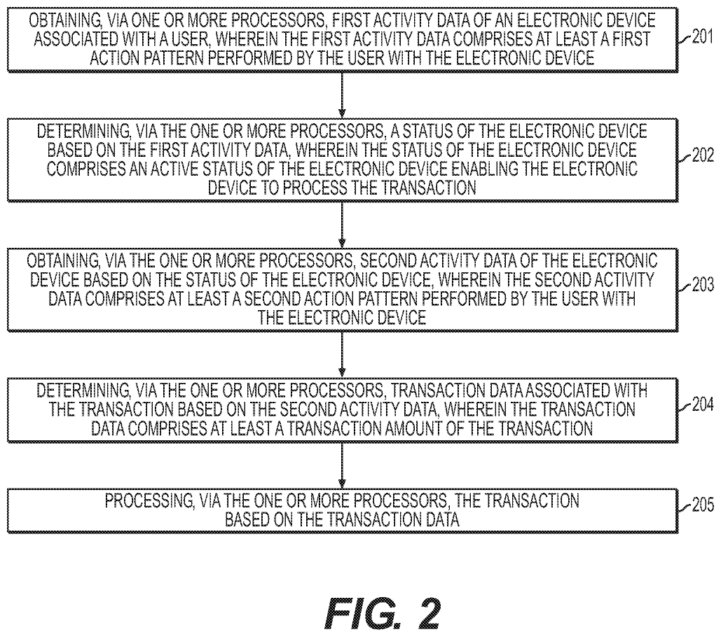

FIG. 2 is a flowchart illustrating a method for processing a transaction, according to one or more embodiments of the present disclosure. The method may be performed by computer system 110.

Step 201 may include obtaining, via one or more processors, first activity data of an electronic device associated with a user. The first activity data may comprise at least a first action pattern performed by the user with the electronic device. The first action pattern may include one or more user actions including shaking, moving, spinning, tilting, flicking, tapping, pressing, or bending the electronic device. The first action pattern may further include additional information regarding user actions towards the electronic device. The additional information may include, but is not limited to, a frequency of a user action (e.g., how many times a user performs a user action in a predetermined period of time), an action time of a user action (e.g., a duration time of performing the user action), or a characteristic of a user action (e.g., a direction of a user action, a force of a user action, etc.). In one example, the first action pattern may include shaking the electronic device from left to right relative to an activity acquiring device (e.g., a sensor) every second. In another example, the first action pattern may include moving the electronic device in a circular motion within 1 minute. In yet another example, the first action pattern may include spinning the electronic device clockwise relative to an activity acquiring device (e.g., a sensor) 3 times in 1 minute. In yet another example, the first action pattern may include first bending the electronic device to 45 degrees and then tilting the electronic device to 90 degrees relative to an activity acquiring device (e.g., a sensor) within 30 seconds. It is noted that the above listed first action pattern activities are merely exemplary and the disclosure encompasses additional such action pattern activities.

The obtaining the first activity data of the electronic device may include obtaining the first activity data via one or more sensors (or activity acquiring devices) associated with the electronic device. The one or more sensors may be contained within or positioned on the electronic device. For instance, if the electronic device is a card, the one or more sensors may include a micro-detector placed on, embedded within, or associated with a chip of the card. In some embodiments, the one or more sensors may be placed externally of the electronic device. For instance, if the electronic device is a card, the one or more sensors may include a reader placed adjacent to the card. The one or more sensors may include at least one of a movement sensor, a light sensor, a pressure sensor, or a proximity sensor. The one or more sensors may further include a microphone, a carbon dioxide sensor, a current sensor, a tilt sensor, a shock detector, an angular rate sensor, a thermometer, a vibration sensor, or a motion detector. If the one or more sensors are placed inside the electronic device, the one or more sensors may be connected with an electronic circuit inside the electronic device. In one example, the first action pattern may include shaking the electronic device from left to right every second, and the sensors placed inside the electronic device may include a movement sensor.

The first activity data may further include biometric data of the user. The biometric data of the user may include any information related to human characteristics of the user. The biometric data may include physiological information such as a fingerprint, palm veins, face recognition, DNA, palm print, hand geometry, iris recognition, a body temperature, retina, or odor/scent. The biometric data may also include behavioral characteristics related to the pattern of behavior of the user, including but not limited to typing rhythm/pressure, gait, or voice. If the first activity data includes the biometric data, the electronic device may include one or more sensors to receive such biometric data. For example, the first activity data may include a fingerprint and a first action pattern including shaking the electronic device from left to right every second. In this situation, the electronic device may include a fingerprint sensor to receive the fingerprint and a movement sensor to detect the shaking movement. In another example, the first activity data may include a user-specific body temperature and a first action pattern including spinning the electronic device clockwise 3 times in 1 minute. In this situation, the electronic device may include a thermometer to detect such user-specific body temperature and a movement sensor to detect the spinning movement. In yet another example, the first activity data may include a first action pattern including tapping the electronic device with a finger, a finger nail, a pen, or a wallet edge of the user every second. In this situation, the electronic device may include a vibration sensor to detect the tapping movement.

Step 202 may include determining, via the one or more processors, a status of the electronic device based on the first activity data. The status of the electronic device may include an active status of the electronic device enabling the electronic device to process a transaction. The status of the electronic device may also include a non-active status. The non-active status may not enable (e.g., prevent, inhibit, disable, etc.) the electronic device from processing the transaction.

The determining a status of the electronic device associated with the user may include comparing the first activity data and pre-stored activity data. The comparing the first activity data and pre-stored activity data may include matching the first activity data and pre-stored activity data. For instance, if the first activity data includes a fingerprint and a first action pattern, comparing the first activity data and pre-stored activity data may include comparing or matching the fingerprint and a pre-stored fingerprint, and comparing or matching the first action pattern and a pre-stored action pattern. The determining a status of the electronic device may include determining a status of the electronic device based on a match (e.g., a complete match or a match equal to or exceeding a predetermined threshold of similarity) between the first activity data and pre-stored activity data. For instance, if the first activity data matches pre-stored activity data, then an active status of the electronic device may be determined. In another example, if the first activity data does not match pre-stored activity data, then a non-active status of the electronic device may be determined.

The pre-stored activity data may be generated when a user or an electronic device is registered with one or more sources 140, a transaction system, or an authentication system. In other embodiments, the pre-stored activity data may be generated when an electronic device first connects with one or more sources 140, a transaction system, or an authentication system. If the electronic device is an electronic mobile device, the pre-stored activity data may be generated when a mobile application for authenticating identification is downloaded, installed, or running on the electronic device for the first time. The pre-stored activity data may be generated when a user account is registered with one or more sources 140, a transaction system, or an authentication system, and the pre-stored activity data may correspond to the electronic device used for registration of the user account. Once the pre-stored activity data has been generated, it may be stored with other user account information and/or verification information. The pre-stored activity data may be stored in one or more memory units, cookies, caches, browsing histories, and/or browser fingerprints, associated with one or more sources 140. The pre-stored activity data may be stored in a memory on-board one or more sensors or on-board the electronic device. The pre-stored activity data may be distributed over multiple devices or systems (e.g., peer-to-peer, cloud-computing based infrastructure, between the reader and an external device).

The pre-stored activity data may comprise at least a pre-stored action pattern performed by the user with the electronic device. The pre-stored action pattern may include one or more user actions including shaking, moving, spinning, tilting, flicking, tapping, pressing, or bending the electronic device. The pre-stored first action pattern may further include additional information regarding user actions towards the electronic device. The additional information may include, but are not limited to, a frequency of a user action (e.g., how many times a user performs a user action in a predetermined period of time), an action time of a user action (e.g., a duration of performing the user action), or a characteristic of a user action (e.g., a direction, force, or speed of a user action). For example, the pre-stored first action pattern may include shaking the electronic device from left to right relative to an activity acquiring device (e.g., a sensor) every second. The pre-stored activity data may include biometric data of the user. Details of the biometric data are described elsewhere herein.

The pre-stored activity data may be subject to adjustment by the user. For instance, the user may adjust the pre-stored activity data by adjusting the pre-stored activity pattern (e.g., adjusting the pre-stored activity data from shaking the electronic device 3 times in a minute to bending the electronic device 3 times in a minute). In another example, the user may adjust the pre-stored activity data by adding biometric data to a pre-stored activity pattern. In some embodiments, the user may update the pre-stored activity data during a period of time. The period of time may be at least 1 day, 1 week, 1 month, 1 quarter, 1 year or longer. In other embodiments, the period of time may be at most 1 year, 1 quarter, 1 month, 1 week, 1 day or shorter.

Step 203 may include obtaining, via the one or more processors, second activity data of the electronic device based on the status of the electronic device. The second activity data may include at least a second action pattern performed by the user with the electronic device. The second action pattern may include one or more user actions including shaking, moving, spinning, tilting, flicking, tapping, pressing, or bending the electronic device. The second action pattern may further include additional information regarding user actions towards the electronic device. The additional information may include, but are not limited to, a frequency of a user action (e.g., how many times a user performs a user action in a predetermined period of time), an action time of a user action (e.g., a duration of time to perform the user action), or a characteristic of a user action (e.g., a direction, speed, or force of a user action).

The second activity data may further include biometric data of the user. Details of the biometric data of the user are described elsewhere herein. If the second activity data includes the biometric data, the electronic device or an activity acquiring device associated with the electronic device may include one or more sensors to receive such biometric data. For example, the second activity data may include a fingerprint and a second action pattern including shaking the electronic device from left to right every second. In this situation, the electronic device may include a fingerprint sensor to receive the fingerprint and a movement sensor to detect the shaking movement. In another example, the second activity data may include a user-specific body temperature and a second action pattern including spinning the electronic device clockwise 3 times in 1 minute. In this situation, the electronic device may include a thermometer to detect such user-specific body temperature and a movement sensor to detect the spinning movement.

The second activity data may be the same as, or different from, the first activity data. In some embodiments, the first activity data may be used to activate the electronic device (e.g., enabling the electronic device to perform a transaction), and the second activity data may be utilized to provide transaction data of a transaction. For instance, upon receipt of the first activity data, the electronic device may be configured to be activated, and upon receipt of second activity data, the electronic device may be configured to process a transaction. In one example, the first activity data (including the first action pattern (e.g., shaking the electronic device from left to right every second)) may be used to activate the electronic device, and the second activity data (including the second action pattern (e.g., moving the electronic device in a circular motion within 1 minute)) may be used to provide a transaction amount of a transaction.

The electronic device may be a transaction vehicle such as a card, including a credit card or a debit card. The card may include one or more card components (e.g., a strip, a circuit, a chip, a token, a sticker, etc.) to enable the card to perform the methods disclosed herein. For example, a card may include an RFID chip, and the RFID chip may interact with one or more sensors during a transaction. In another example, a card may include one or more stickers, and tapping on the sticker(s) or pressing the sticker(s) in a pattern (e.g., tapping/pressing a first sticker, then a second sticker, and finally tapping the first sticker again) by a user may activate and/or authorize the card, indicate a transaction amount, lock the card for a period of time (e.g., one day), or indicate an approval of a transaction amount. The one or more card components may store cryptographic keys (e.g., a digital signature), passwords, or biometric data (e.g., fingerprint details). The one or more card components may communicate with one or more sensors through near-field communication (NFC), radio-frequency identification (RFID), or Bluetooth. Information stored in or associated with the card (e.g., pre-stored activity data) may be encrypted and may have an expiration period. Such information may be encrypted by one or more protocols including Internet Key Exchange, IPsec, Kerberos, Point to Point Protocol, Secure Shell, or Transport Layer Security. The expiration period may be at least 1 day, 1 week, 1 month, 1 quarter, 1 year or longer. In other embodiments, the expiration period may be at most 1 year, 1 quarter, 1 month, 1 week, 1 day or shorter.

The electronic device may include an electric circuit. Such an electric circuit may include or be connected to one or more connection interfaces, microcontrollers, or one or more switches. The one or more connection interfaces may include one or more input-output interfaces or modular connection interfaces. The input-output interfaces or the modular connection interfaces may allow signals or data exchange among different components of the electric circuit. The modular connection interfaces may include one or more communication interfaces. The one or more communication interfaces may include one or more components used for signal or data exchange (e.g., plug and socket, connectors, wires, etc.). Mechanical, electrical, and/or logical signals or data may pass across the one or more components. One or more interface protocols may be used for sequencing the signals or data. A microcontroller may be configured to obtain and analyze data (e.g., first activity data or second activity data). The microcontroller may be configured to determine a status of the electronic device based on the first activity data. The microcontroller may comprise a processor and memory on a single chip. The processor may be a 4-bit, 8-bit, 16-bit, 32-bit or 64-bit processor. The memory may comprise random access memory (RAM), flash memory, erasable programmable read-only memory (EPROM) or electrically erasable programmable read-only memory (EEPROM). The microcontroller may be connected to the one or more connection interfaces. The microcontroller may be connected to one or more sensors of the electronic device. In some embodiments, the electronic device may include a push button (or other such mechanical actuator/switch) that a user can push (or otherwise actuate) to activate the electronic device.

The obtaining the second activity data of the electronic device may include obtaining the second activity data via one or more sensors associated with the electronic device. The one or more sensors may include at least one of a movement sensor, a light sensor, a pressure sensor, or a proximity sensor. The one or more sensors may further include a microphone, a carbon dioxide sensor, a current sensor, a tilt sensor, a shock detector, an angular rate sensor, a thermometer, or a motion detector. The one or more sensors may be contained within and/or connected to the electronic circuit of the electronic device. In some embodiments, the one or more sensors may be placed externally of the electronic device. In one example, the second action pattern may include shaking the electronic device from left to right every second, and the sensors may include a movement sensor. In another example, the second activity data may include a user-specific body temperature and a second action pattern may include moving the electronic device in a circular motion within 1 minute. In this situation, the sensors may include a movement sensor and a thermometer.

The one or more sensors may include a reader. The reader may be a near-field communication reader. A reader may communicate with an electronic device to identify a user and/or permit transactions. The reader may receive information (e.g., first activity data or second activity data) from an electronic device when the electronic device is placed adjacent to the reader. The information from an electronic device may be assessed by the reader, or another external device to verify user identity and/or permit a transaction. If the electronic device is a card, the reader may be configured to communicate with one or more card components (e.g., a strip, a circuit, a chip, a token, etc.) of the card. The reader may be able to detect a movement of an electronic device. The reader may further include one or more sensors such as a proximity sensor, a radio-frequency identification tag, or a magnet. In some embodiments, the reader may be in proximity to a machine or a person that handles payments at a transaction entity (e.g., a financial service provider or merchant). The reader may include a reader display. The reader display may include a liquid crystal display, a light-emitting diode display, a plasma display, a segment display, or a multi-dimensional display. The reader display may demonstrate any information regarding a user or a transaction to be processed.

Step 204 may include determining, via the one or more processors, transaction data associated with the transaction based on the second activity data. The transaction data may include at least a transaction amount of the transaction. The transaction data may further include at least one of a transaction location, a transaction type, or a transaction time of the transaction. The transaction data may include any information regarding a real-time transaction to be performed by the user, for example, a user identifier, contact information (e.g., address, phone numbers, e-mail addresses, etc.), demographic information (e.g., age, gender, marital status, income level, educational background, number of children in household, etc.), or user preferences (preferences or reviews regarding favorite products and/or services, favorite department stores, etc.). The transaction data may also include any information regarding a historical transaction performed by the user. Such transaction data may include a time of a prior transaction, a location of a prior transaction, spending profile of a user, past spending levels on goods/services sold by various manufacturers or merchants, a frequency of shopping by the user at one or more merchants, how much the user spends in an average transaction, how much the user has spent on a particular product, how often the user shops in a particular store or kind of merchant, or on-line or offline stores at which the user has purchased items.

The determining the transaction data may include comparing the second activity data and pre-stored activity data. The comparing the second activity data and pre-stored activity data may include matching the second activity data and pre-stored activity data. For instance, if the second activity data includes a fingerprint and a second action pattern, comparing the second activity data and pre-stored activity data may include comparing or matching the fingerprint and a pre-stored fingerprint, and comparing or matching the second action pattern and a pre-stored action pattern. The determining the transaction data may include determining the transaction data based on a match (e.g., a complete match or a match equal to or exceeding a predetermined threshold of similarity) between the second activity data and pre-stored activity data. In some embodiments, if the second activity data matches pre-stored activity data, then certain transaction data (e.g., a transaction amount) may be determined.

For instance, pre-stored activity data including tapping (e.g., a user hits the electronic device with his/her fingers, or a user moves the electronic device to hit on his/her hand) the electronic device once may be associated with approving a transaction after a user knows (e.g., is presented with) a transaction amount of the transaction (e.g., via a point of sale device or otherwise), then a second activity data that completely matches such pre-stored activity data may mean the same—approving the transaction. In other words, in a first arrangement, second activity data that matches pre-stored activity data may be indicative of an approval by the user of a transaction to be processed, and determining the transaction data may include receiving the transaction data following such approval. In another example, pre-stored activity data including tilting the electronic device may be used to confirm an approximate price or transaction amount as a way of indicating approval by the user for the transaction to occur. For example, tilting the electronic device to the right may be indicative of an approximate value of $10. To confirm approval of a transaction having a transaction amount of $56, the user may tilt the device to the right six times (e.g., rounding to the nearest $10 increment). In such an arrangement, determining the transaction data may include determining an estimated transaction amount based on the second activity data (e.g., an estimate of $60 based on the second activity data) and/or receiving the transaction data once the user has approved the transaction (e.g., by virtue of the second activity data of tilting the electronic device to the right six times so as to approve a transaction amount of approximately $60).

Step 205 may include processing, via the one or more processors, the transaction based on the transaction data. Such transaction may be performed at any transaction entity, including, financial service providers 141, on-line resources 142, or other third party entities 143. In one example, a user may bring an electronic device 150 such as a mobile phone to a grocery store to buy a product. The user may first activate a payment method installed on the mobile phone (e.g., Apple pay) via first activity data (e.g., shaking the mobile phone four times in 1 minute), and then may provide a transaction amount of the product (e.g., how much the user pays for the product) based on second activity data (e.g., tapping the mobile phone 3 times meaning the product is approximately 30 dollars). In this situation, the transaction of buying the product may be processed, based on the transaction data. In another example, a user may bring an electronic device 150 such as a mobile phone to a restaurant to pay for a meal. The user may first activate a payment method installed on the mobile phone (e.g., Apple pay) via first activity data (e.g., tapping the mobile phone twice in 1 minute), and, after knowing the price of the meal, approve the transaction to pay for the meal based on second activity data (e.g., tilting the mobile phone once meaning approving a transaction). In this situation, the transaction of paying the meal may be processed, based on the transaction data. In yet another example, a user may bring a debit card to a bank to withdraw money. The user may first activate the debit card via his or her fingerprint and a first activity pattern (e.g., rotating the debit card 3 times in a minute), and then may provide a transaction amount (e.g., how much the user wants to withdraw) based on second activity data (e.g., moving the card up and downs 5 times for withdrawing 500 dollars). In this situation, the transaction of withdrawing 500 dollars may be processed, based on the transaction data.

At any stage of processing the transaction, the method may further include obtaining third activity data or fourth activity data, or more, to facilitate the transaction. The third activity data or fourth activity data may be the same as, or different from, the first activity data or the second activity data. For instance, a user may bring an electronic device 150 such as a mobile phone to a department store to pay for a pair of shoes. The user may first activate a payment method installed on the mobile phone (e.g., Apple pay) via first activity data (e.g., tapping the mobile phone twice in 1 minute), and, after knowing the price of the pair of shoes, approve the transaction to pay for the pair of shoes based on second activity data (e.g., shaking the mobile phone once meaning approving a transaction). Additionally, the user may activate a discount or promotion (e.g., a coupon, membership discount code, credit card store promotion on purchases, specific bank credit card promotion) associated with the transaction to pay for the pair of shoes, and/or the user may allow such discount via third activity data (e.g., moving the electronic device up).

At any stage of processing the transaction, the method may further include transmitting, to the user, a notification indicative of the transaction. The notification may include any information associated with the transaction and the user. The notification may be configured to be displayed on a display screen of a reader or an electronic device. The notification may be displayed on the display screen in any suitable form, such as an e-mail, a text message, a push notification, content on a web page, and/or any form of graphical user interface. The reader or the electronic device may be capable of accepting inputs of the user via one or more interactive components, such as a keyboard, button, mouse, touchscreen, touchpad, joystick, trackball, camera, microphone, or motion sensor. There may be steps of performing a secondary verification for processing a transaction. A secondary verification request may be presented to the user via a display of a reader or an electronic device. In some embodiments, the secondary verification may include additional activity data provided by the user. In some other embodiments, the secondary verification may be provided by a user via one or more interactive activities of the user with the reader or the electronic device. The electronic device or the reader may be capable of accepting inputs of a user via one or more interactive components of the electronic device, such as a keyboard, button, mouse, touchscreen, touchpad, joystick, trackball, camera, microphone, or motion sensor input (e.g., an input device 450 as described in connection with FIG. 4, below). For instance, the user may type his/her user name, address, or social security number via a keyboard provided on the display of the electronic device. In another example, the user may click on one or more selections displayed on a display of the electronic device. The one or more selections may be in a form of a link, button, or hyperlink, etc.

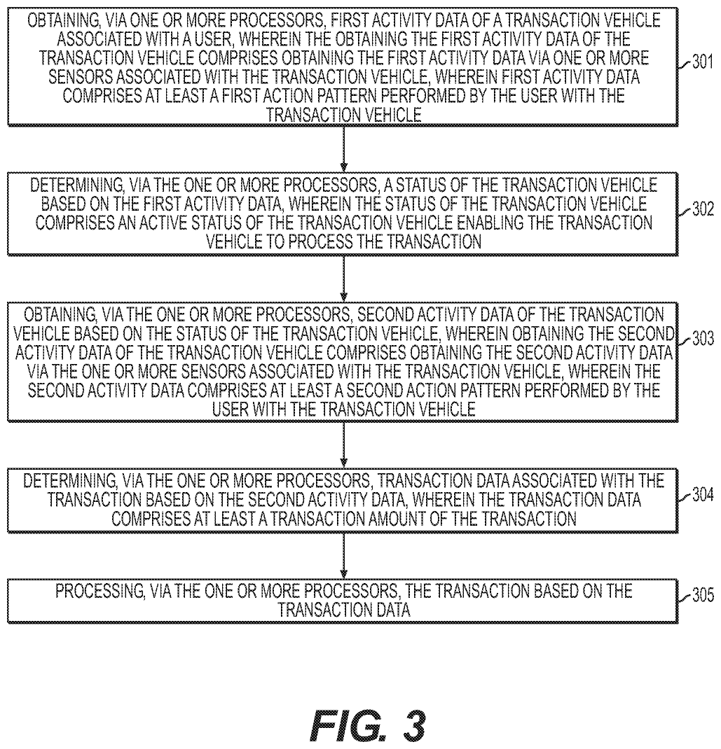

FIG. 3 is a flowchart illustrating another exemplary method for processing a transaction, according to one or more embodiments of the present disclosure. The method may be performed by computer system 110.

Step 301 may include obtaining, via one or more processors, first activity data of a transaction vehicle associated with a user. The first activity data may include at least a first action pattern performed by the user with the transaction vehicle. The first action pattern may include one or more user actions including shaking, moving, spinning, tilting, flicking, tapping, pressing, or bending the electronic device. The first activity data may further includes biometric data of the user. The transaction vehicle (which is an electronic device) may be a credit card or a debit card. Details of the first activity data, the first action pattern, biometric data, and the electronic device are described elsewhere herein. The obtaining the first activity data of the transaction vehicle may include obtaining the first activity data via one or more sensors associated with the transaction vehicle. The one or more sensors may include at least one of a movement sensor, a light sensor, a pressure sensor, or a proximity sensor. Additional details of the one or more sensors are described elsewhere herein.

Step 302 may include determining, via the one or more processors, a status of the transaction vehicle based on the first activity data. The status of the transaction vehicle may include an active status of the transaction vehicle enabling the transaction vehicle to process the transaction. The status of the electronic device may also include a non-active status. The non-active status may not enable (e.g., prevent, inhibit, disable, etc.) the electronic device from processing the transaction. The determining a status of the transaction vehicle associated with the user may include comparing the first activity data and pre-stored activity data. The determining a status of the transaction vehicle may include determining a status of the transaction vehicle based on a match (e.g., a complete match or a match equal to or exceeding a predetermined threshold of similarity) between the first activity data and pre-stored activity data. For instance, if the first activity data matches pre-stored activity data, then an active status of the transaction vehicle may be determined. In another example, if the first activity data does not match pre-stored activity data, then a non-active status of the transaction vehicle may be determined. The pre-stored activity data may be subject to adjustment by the user, as described elsewhere herein. Details of the pre-stored activity data are described elsewhere herein.

Step 303 may include obtaining, via the one or more processors, second activity data of the transaction vehicle based on the status of the transaction vehicle. The obtaining the second activity data of the transaction vehicle may include obtaining the second activity data via the one or more sensors associated with the transaction vehicle. The second activity data may include at least a second action pattern performed by the user with the transaction vehicle. The second action pattern may include one or more user actions including shaking, moving, spinning, tilting, flicking, tapping, pressing, or bending the transaction vehicle. Details of the second activity data, the one or more sensors, and the second action pattern are described elsewhere herein.

Step 304, similar to step 204, may include determining, via the one or more processors, transaction data associated with the transaction based on the second activity data. The transaction data may include at least a transaction amount of the transaction. The transaction data may further include at least one of a transaction location, a transaction type, or a transaction time of the transaction. The determining the transaction data may include comparing the second activity data and pre-stored activity data. The comparing the second activity data and pre-stored activity data may include matching the second activity data and pre-stored activity data. For instance, if the second activity data includes the a fingerprint and a second action pattern, comparing the second activity data and pre-stored activity data may include comparing or matching the fingerprint and a pre-stored fingerprint, and comparing or matching the second action pattern and a pre-stored action pattern. The determining the transaction data may include determining the transaction data based on a match (e.g., a complete match or a match equal to or exceeding a predetermined threshold of similarity) between the second activity data and pre-stored activity data. For instance, if the second activity data matches pre-stored activity data, then certain transaction data (e.g., a transaction amount) may be determined. Details of the pre-stored activity data and transaction data are disclosed elsewhere herein.

Step 305, similar to step 205, may include processing, via the one or more processors, the transaction based on the transaction data. Such transaction may be performed at any transaction entity, including, financial service providers 141, on-line resources 142, or other third party entities 143. In one example, a user may bring a credit card to a grocery store to buy a product. The user may first activate the credit card via first activity data (e.g., shaking the card four times in 1 minute), and then may provide a transaction amount of the product (e.g., how much to pay for the product) based on second activity data (e.g., bending the card 3 times meaning the product is 30 dollars). In this situation, the transaction of buying the product may be processed, based on the transaction data. At any stage of processing the transaction, the method may further include transmitting, to the user, a notification indicative of the transaction. The notification may include any information associated with the transaction and the user. Details of the notification are described elsewhere herein.

The status of a transaction vehicle or an electronic device, or transaction data may be determined via a trained machine learning algorithm. In this situation, the first activity data or the second activity data may not be a match to any pre-stored activity data. The trained machine learning algorithm may include a regression-based model that accepts first activity data, second activity data, a status of a transaction vehicle or an electronic device, or transaction data as input data. The trained machine learning algorithm may be part of the algorithm model 112. The trained machine learning algorithm may be of any suitable form, and may include, for example, a neural network. A neural network may be software representing human neural system (e.g., cognitive system). A neural network may include a series of layers termed “neurons” or “nodes.” A neural network may comprise an input layer, to which data is presented; one or more internal layers; and an output layer. The number of neurons in each layer may be related to the complexity of a problem to be solved. Input neurons may receive data being presented and then transmit the data to the first internal layer through connections' weight. A neural network may include a convolutional neural network, a deep neural network, or a recurrent neural network.

The machine learning algorithm may be trained by supervised, unsupervised, or semi-supervised learning using training sets comprising data of types similar to the type of data used as the model input. For example, the training set used to train the model may include any combination of the following: prior first activity data of the user, prior second activity data of the user, prior status of a transaction vehicle or an electronic device of the user, prior transaction data of the user, prior first activity data of customers other than the user, prior second activity data of customers other than the user, prior status of a transaction vehicle or an electronic device of customers other than the user, or prior transaction data of customers other than the user. Additionally, the training set used to train the model may further include user data, including, but not limited to, an actual name, contact information (e.g., address, phone numbers, e-mail addresses, etc.), and other data related to the user. Accordingly, the machine learning model may be trained to map input variables to a quantity or value of the transaction data for the user. That is, the machine learning model may be trained to determine a quantity or value of the transaction data of the user as a function of various input variables.

In general, any process discussed in this disclosure that is understood to be computer-implementable, such as the processes illustrated in FIGS. 2-3, may be performed by one or more processors of a computer system, such as computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as computer system 110, and/or electronic device 150, may include one or more computing devices. If the one or more processors of the computer system 110, and/or electronic device 150 are implemented as a plurality of processors, the plurality of processors may be included in a single computing device or distributed among a plurality of computing devices. If a computer system 110, and/or electronic device 150 comprises a plurality of computing devices, the memory of the computer system 110 and/or electronic device 150 may include the respective memory of each computing device of the plurality of computing devices.

FIG. 4 illustrates an example of a computing device 400 of a computer system, such as computer system 110 and/or electronic device 150. The computing device 400 may include processor(s) 410 (e.g., CPU, GPU, or other such processing unit(s)), a memory 420, and communication interface(s) 440 (e.g., a network interface) to communicate with other devices. Memory 420 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 420. The computing device 400 may, in some embodiments, further include input device(s) 450 (e.g., a keyboard, mouse, or touchscreen) and output device(s) 460 (e.g., a display, printer). The aforementioned elements of the computing device 400 may be connected to one another through a bus 430, which represents one or more busses. In some embodiments, the processor(s) 410 of the computing device 400 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

1. A computer-implemented method for processing a transaction, the computer-implemented method comprising:
obtaining, via one or more processors operably connected to one or more sensors, first activity data of an electronic device associated with a user, wherein the electronic device is a credit card or a debit card, the one or more sensors include a micro-detector placed on or embedded within a chip of the credit card or the debit card, and the first activity data comprises at least a first action pattern performed by the user with the micro-detector of the electronic device;
determining, via the one or more processors, a status of the electronic device based on the first activity data by:
comparing the first action pattern to a pre-stored action pattern to determine whether the first action pattern matches the pre-stored action pattern, the pre-stored action pattern including one or more user actions and additional information regarding the one or more user actions, the one or more user actions including shaking, moving, spinning, tilting, flicking, tapping, pressing, or bending the electronic device, the additional information including a frequency, an action time, or a characteristic of a particular user action of the one or more user actions; and
in response to determining the first action pattern matches the pre-stored action pattern, determining the status of the electronic device as an active status of the electronic device enabling the electronic device to process the transaction;
obtaining, via the one or more processors, second activity data of the electronic device based on the status of the electronic device, wherein the second activity data comprises at least a second action pattern performed by the user with the electronic device;
determining, via the one or more processors, transaction data associated with the transaction based on the second action pattern of the second activity data, wherein the transaction data comprises at least a transaction amount of the transaction; and
processing, via the one or more processors, the transaction based on the transaction data.

2. The computer-implemented method of claim 1, wherein the second action pattern includes one or more of shaking, moving, spinning, tilting, flicking, tapping, pressing, or bending the electronic device.

3. (canceled)

4. (canceled)

5. The computer-implemented method of claim 1, wherein obtaining the second activity data of the electronic device includes obtaining the second activity data via the micro-detector of the one or more sensors.

6. The computer-implemented method of claim 5, wherein the micro-detector is one of a movement sensor, a light sensor, a pressure sensor, or a proximity sensor.

7. The computer-implemented method of claim 1, wherein the first activity data or the second activity data further includes biometric data of the user.

8. (canceled)

9. The computer-implemented method of claim 1, wherein the pre-stored action pattern is subject to adjustment by the user.

10. The computer-implemented method of claim 1, wherein the transaction data further includes at least one of a transaction location, a transaction type, or a transaction time of the transaction.

11. The computer-implemented method of claim 1, further including transmitting, to the user, a notification indicative of the transaction.

12. A computer-implemented method for processing a transaction, the computer-implemented method comprising:
obtaining, via one or more processors, first activity data of a transaction vehicle associated with a user, wherein obtaining the first activity data of the transaction vehicle comprises obtaining the first activity data via one or more sensors associated with the transaction vehicle, the transaction vehicle is a card, the card includes one or more card components to enable the card to process the transaction, the one or more card components include one or more stickers, and the first activity data comprises at least a first action pattern performed by the user with the transaction vehicle by tapping or pressing the one or more stickers;
determining, via the one or more processors, a status of the transaction vehicle based on the first activity data by:
comparing the first action pattern to a pre-stored action pattern to determine whether the first action pattern matches the pre-stored action pattern, the pre-stored action pattern including one or more user actions, the one or more user actions including tapping or pressing the one or more stickers of the transaction vehicle in a pattern; and
in response to determining the first action pattern matches the pre-stored action pattern, determining the status of the transaction vehicle as an active status of the transaction vehicle enabling the transaction vehicle to process the transaction;
obtaining, via the one or more processors, second activity data of the transaction vehicle based on the status of the transaction vehicle, wherein obtaining the second activity data of the transaction vehicle comprises obtaining the second activity data via the one or more sensors associated with the transaction vehicle, wherein the second activity data comprises at least a second action pattern performed by the user with the transaction vehicle;
determining, via the one or more processors, transaction data associated with the transaction based on the second action pattern of the second activity data, wherein the transaction data comprises at least a transaction amount of the transaction; and
processing, via the one or more processors, the transaction based on the transaction data.

13. The computer-implemented method of claim 12, wherein the second action pattern includes one or more of shaking, moving, spinning, tilting, flicking, tapping, pressing, or bending the transaction vehicle.

14. The computer-implemented method of claim 12, wherein the card is a credit card or a debit card.

15. (canceled)

16. The computer-implemented method of claim 12, wherein the first activity data or the second activity data further includes biometric data of the user.

17. (canceled)

18. The computer-implemented method of claim 12, wherein the pre-stored action pattern is subject to adjustment by the user.

19. The computer-implemented method of claim 12, wherein the transaction data further includes at least one of a transaction location, a transaction type, or a transaction time of the transaction.

20. A computer system for processing a transaction, comprising:
a memory storing instructions; and
one or more processors configured to execute the instructions to perform operations including:
obtaining, via one or more sensors, first activity data of an electronic device associated with a user, wherein the electronic device is a credit card or a debit card, the one or more sensors include a micro-detector placed on or embedded within a chip of the credit card or the debit card, and the first activity data comprises at least a first action pattern performed by the user with the micro-detector of the electronic device;
determining a status of the electronic device based on the first activity data by:
comparing the first action pattern to a pre-stored action pattern to determine whether the first action pattern matches the pre-stored action pattern, the pre-stored action pattern including one or more user actions and additional information regarding the one or more user actions, the one or more user actions including shaking, moving, spinning, tilting, flicking, tapping, pressing, or bending the electronic device, the additional information including a frequency, an action time, or a characteristic of a particular user action of the one or more user actions; and
in response to determining the first action pattern matches the pre-stored action pattern, determining the status of the electronic device as an active status of the electronic device enabling the electronic device to processing the transaction;
obtaining second activity data of the electronic device based on the status of the electronic device, wherein the second activity data comprises at least a second action pattern performed by the user with the electronic device;
determining transaction data associated with the transaction based on the second action pattern of the second activity data, wherein the transaction data comprises at least a transaction amount of the transaction; and
processing the transaction based on the transaction data.
